(19) United States
(12) Patent Application Publication
(10) Pub. No.: US 2011/0181033 A1
(43) Pub. Date: Jul. 28, 2011

(54) APPARATUS AND METHOD TO VERIFY IDENTITY AND DOCUMENTS

(76) Inventors: THOMAS C. FINLEY, SAHUARITA, AZ (US); JOHN J. HAMMER, SAHUARITA, AZ (US)

(21) Appl. No.: 11/866,934

(22) Filed: Oct. 3, 2007

Related U.S. Application Data
(60) Provisional application No. 60/828,041, filed on Oct. 3, 2006.

(51) Int. Cl. B42D 15/00

(52) U.S. Cl. 283/67

(57) ABSTRACT

A method to verify the authenticity of an identification document comprising one or more physical characteristics, one or more text areas, and one or more design elements, by determining if the one or more physical characteristics can be verified, and determining if the one or more text areas can be verified, and determining if the one or more design elements can be verified.

### CROSS REFERENCE TO RELATED APPLICATIONS

This Application claims priority from a U.S. Provisional Application having a Ser. No. 60/828,041 filed Oct. 3, 2006, which is hereby incorporated herein by reference.

### FIELD OF THE INVENTION

The present invention relates to methods and systems for validating the authenticity of an identification, travel, or other document, proffered by a person carrying that document.

### BACKGROUND OF THE INVENTION

The ability to verify the authenticity of identification (“ID”) documents has increased in importance with the growing threat of terrorism. New technologies, such as holograms and retro-reflective layers in laminating materials, have been incorporated to hinder, if not make impossible, the alteration and counterfeiting of such ID documents. However, these technologies do not aid law enforcement, security agents, employers, air travel personal, and others in verifying the authenticity of identification documents, if those individuals have not been properly trained to identify and verify the composition and placement of various features recited on such identification documents. In addition, these technologies do not aid security personnel when those personnel examine authentic identity documents that have been fraudulently obtained.

There are many ways real ID documents can end up in the hands of criminals or terrorists. Individuals may have been issued valid identity or travel documents prior to becoming criminals or being identified as terrorists. ID documents may be wrongfully issued by corrupt officials for a fee, often with false identification information. An individual may steal the identification of another person by obtaining duplicate birth certificates and records, which are then used to fraudulently obtain “valid” documents, including passports and national identity cards. Additionally, many important ID documents have relatively long periods of validity, for example ten years or more. This presents an extended window of opportunity for trafficking in valid documents for fraudulent use. It is, for example, possible for documents belonging to a deceased person to remain valid for many years after their death, unless some action is taken to cancel the documents. Accordingly, validation and verification terminals designed to detect altered and counterfeit identity and travel documents will not detect such “valid” documents that have been wrongfully issued and are in use by criminals and terrorists

One possible solution involves the implementation of a national ID system with a centralized database. This highly expensive option proposes to provide little improvement in positive identification of individuals over systems currently in place. Further, a national ID system would require years to complete—granting that “privacy” litigation did not delay or halt the development and implementation of such a system all-together. Thus, there is a need for a method and system to validate the authenticity of identification documents which can be implemented quickly and cost effectively.

### SUMMARY OF THE INVENTION

Accordingly, the present invention relates to a method and corresponding system for validating a currently existing identification (ID), travel, or other document and relating the document to the bearer.

One aspect of the invention includes a database of information and sample documents currently existing that have an identification function, but are intended for other uses. Various embodiments of the database may include driver licenses, United States passports and visas, social security cards, and documents from foreign countries. The method and corresponding system allows the user to validate a given ID document against the appropriate security features for that specific ID document. The facial features of the bearer of the document may also be compared to the actual photograph on the ID document and validated through a systematic approach.

Another method and corresponding system is provided for validating existing identification documents specifically used in processing Form I-9 (Employment Eligibility Verification).

The method and corresponding system of the present invention offers immediate improvements to security and cost over methods in existence or currently being contemplated.

### BRIEF DESCRIPTION OF THE DRAWINGS

The foregoing will be apparent from the following more particular description of example embodiments of the invention, as illustrated in the accompanying drawings. The drawings are not necessarily to scale, emphasis instead being placed upon illustrating embodiments of the present invention.

FIG. 1A is a block diagram illustrating one embodiment of Applicants' apparatus;

FIG. 1B is a perspective view showing Applicants' hand-held computing device in bi-directional wireless communication with a vehicle, wherein that vehicle is in bi-directional wireless communication with a second computing device;

FIG. 2 is a perspective view showing one embodiment of Applicants' portable device;

FIG. 3 is a block diagram showing the components of the device of FIG. 2;

FIG. 4 is a flow chart summarizing the initial steps of Applicants' method;

FIG. 5A is a flow chart summarizing additional steps of Applicants' method;

FIG. 5B is a flow chart summarizing additional steps of Applicants' method;

FIG. 6 is a flow chart summarizing additional steps of Applicants' method; and

FIG. 7 is a flow chart summarizing additional steps of Applicants' method.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As a general matter, Applicants' system comprises a plurality of databases, in combination with a plurality of requesting devices, each in bi-directional communication with Applicants' host computer. In certain embodiments, the plurality of databases comprises one or more databases maintained by one or more agencies of the federal government, such as and without limitation the Social Security Administration. In certain embodiments, the plurality of databases comprises one or more databases maintained by one or more agencies of one or more state governments, such as and without limitation the Motor Vehicle Departments. In certain embodiments, the plurality of requesting devices are operated by one or more subscribing agencies of the several States and/or political subdivisions thereof, such as and without limitation a state Highway Patrol, a County Sheriff Department, a city Police Department, and the like. In certain embodiments, the plurality of requesting devices are operated by one or more subscribing agencies of the federal government, such as and without limitation the Department of Homeland Security, Federal Bureau of Investigation, Department of Alcohol, Tobacco and Firearms, and the like. In certain embodiments, the plurality of requesting devices are operated by one or more subscribing private employers. In certain embodiments, the plurality of requesting devices are operated by one or more subscribing retail sales establishments.

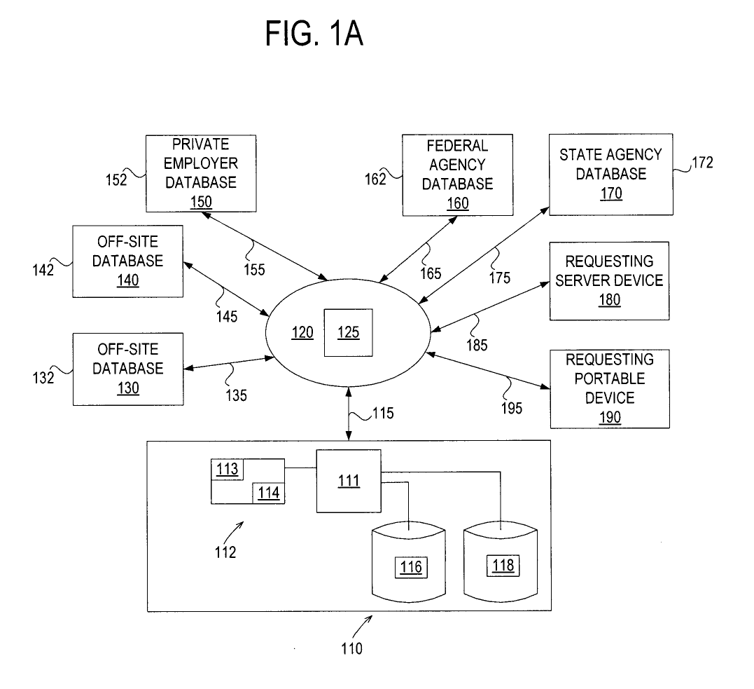

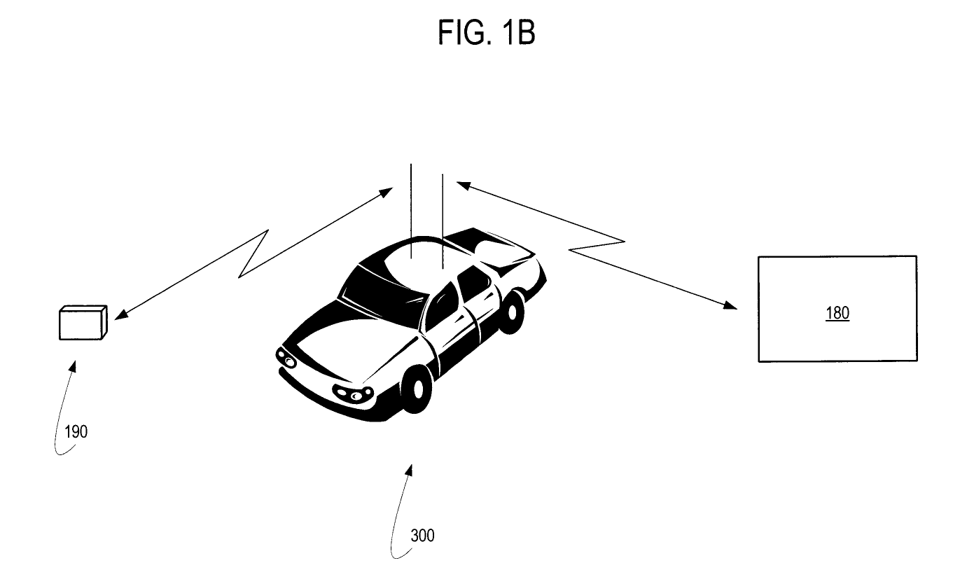

Referring now to FIG. 1, Applicants' system 100 comprises computing devices 132, 142, 152, 162, 172, 180, and 190, in bi-directional communication with Applicants' host computing device 110 via network 120. In the illustrated embodiments of FIG. 1A, computing devices 132, 142, 152, 162, 172, 180, and 190, communicate with network 120 via I/O Interfaces 135, 145, 155, 165, 175, 185, and 195, respectively. I/O interfaces 135, 145, 155, 165, 175, 185, and 195, may be any type of I/O interface, for example, a Fibre Channel, Infiniband, Gigabit Ethernet, Ethernet, TCP/IP, iSCSI, SCSI I/O interface or one or more signal lines used to transfer information through network 120 to Applicants' host computing device 110.

In the illustrated embodiment of FIG. 1A, network 120 is in bi-directional communication with Applicants' host computing device 110 via I/O Interface 115. I/O interface 115 may be any type of I/O interface, for example, a Fibre Channel, Infiniband, Gigabit Ethernet, Ethernet, TCP/IP, iSCSI, SCSI I/O interface or one or more signal lines used to transfer information through network 120 to a plurality of interconnected computing devices each comprising one or more databases.

In the illustrated embodiment of FIG. 1A, database 130 is maintained in a computing device 132 owned and/or operated by a first off-site database provider. In the illustrated embodiment of FIG. 1A, database 140 is maintained in a computing device 142 owned and/or operated by a second off-site database provider. In the illustrated embodiment of FIG. 1A, database 150 is maintained in a computing device 152 owned and/or operated by a private employer.

For the sake of clarity, FIG. 1A shows a single database maintained by a private employer in communication with network 120. In other embodiments, Applicants' system 100 comprises a plurality of databases maintained by private employers in bi-directional communication with Applicants' host computing device 110.

In the illustrated embodiment of FIG. 1A, database 160 is maintained in a computing device 162 owned and/or operated by a first Federal Agency. For the sake of clarity, FIG. 1A shows one Federal Agency in communication with network 120. As a general matter, Applicants' system 100 comprises a plurality of Federal Agencies in bi-directional communication with Applicants' host computing device 110.

In the illustrated embodiment of FIG. 1A, database 170 is maintained in a computing device 172 owned and/or operated by a first State Agency. For the sake of clarity, FIG. 1A shows one State Agency in communication with network 120. As a general matter, a plurality of departments/agencies of the Several States, and political subdivisions thereof, are in bi-directional communication with Applicants' host computing device 110.

In the illustrated embodiment of FIG. 1A, requesting device 180 comprises a computing device such as and without limitation a server, desktop computer, mainframe computer, and the like, and requesting device 190 comprises a portable computing device. For the sake of clarity, FIG. 1A shows one requesting server and one requesting portable device in communication with network 120. As a general matter, Applicants' system 100 comprises a plurality of requesting servers and a plurality of requesting portable devices in bi-directional communication with Applicants' host computing device 110.

Referring now to FIG. 1B, in certain embodiments Applicants' hand-held computing device 190 is in wireless communication with a vehicle, such as vehicle 300 located in near vicinity. In the illustrated embodiment of FIG. 1B, vehicle 300 is in wireless communication with server 180. In the illustrated embodiment of FIG. 1B, a request generated by hand-held computing device 190 is wirelessly received by vehicle 300, vehicle 300 then wirelessly relays that request to server 180, wherein server 180 relays the request to one or more of computing devices 110, 132, 142, 152, 162, and/or 172.

Referring again to FIG. 1A, as a general matter, Applicants' computing device 110 comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; UNIX is a registered trademark in the United States and other countries licensed exclusively through The Open Group; and LINUX is a registered trademark of Linus Torvald.)

In the illustrated embodiment of FIG. 1A, computing device 110 comprises a processor 111, memory 112, and data storage devices 116 and 118. The illustrated embodiment of FIG. 1A shows two data storage devices 116 and 118.

In the illustrated embodiment of FIG. 1A, operating system 113 is stored in memory 112. In the illustrated embodiment of FIG. 1A, Applicants' computer program product 114 is stored in memory 112.

In certain embodiments, data storage device 116 and/or data storage device 118 comprises a magnetic tape data storage device, wherein device 116 and/or device 118 can read data from, and write data to, a magnetic tape removeably disposed therein. In certain embodiments, data storage device 116 and/or data storage device 118 comprises a hard disk data storage device, device 116 and/or device 118 can read data from, and write data to, a hard disk disposed therein. In certain embodiments, data storage device 116 and/or data storage device 118 comprises an optical disk data storage device, device 116 and/or device 118 can read data from, and write data to, an optical disk disposed therein. In certain embodiments, data storage device 116 and/or data storage device 118 comprises electronic storage media. By “electronic storage media,” Applicant means, for example, a device such as a PROM, EPROM, EEPROM, Flash PROM, compactflash, smartmedia, and the like.

In other embodiments, Applicants' host computing device 110 comprises one data storage device. In other embodiments, Applicants' host computing device 110 comprises a plurality of data storage devices. In certain embodiments, that plurality of data storage devices utilize one or more RAID data storage protocols.

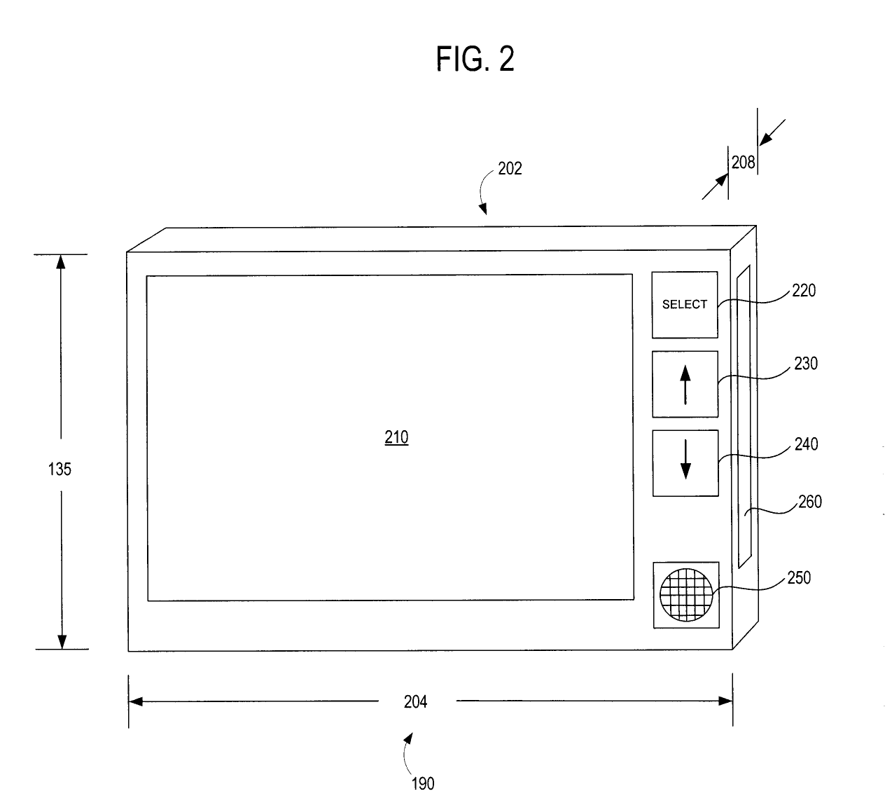

FIG. 2 shows one embodiment of Applicants' portable requesting device 190. Device 190 comprises housing 202, wherein that housing comprises a length 204 between about 1 inches and about 120 inches, a height 206 between about 1 inches and about 120 inches, and a width 208 between about 1 inches and about 120 inches.

Device 190 comprises a display element 210 disposed in housing 202. In certain embodiments, device 190 further comprises identification card input interface 260 through which an identification card can be removeably inserted into device 190. Device 190 further comprises a plurality of buttons/touch screen elements 220, 230, and 240, to scroll through, and select, various menus, and to input data, to implement the steps of Applicants' method described hereinbelow.

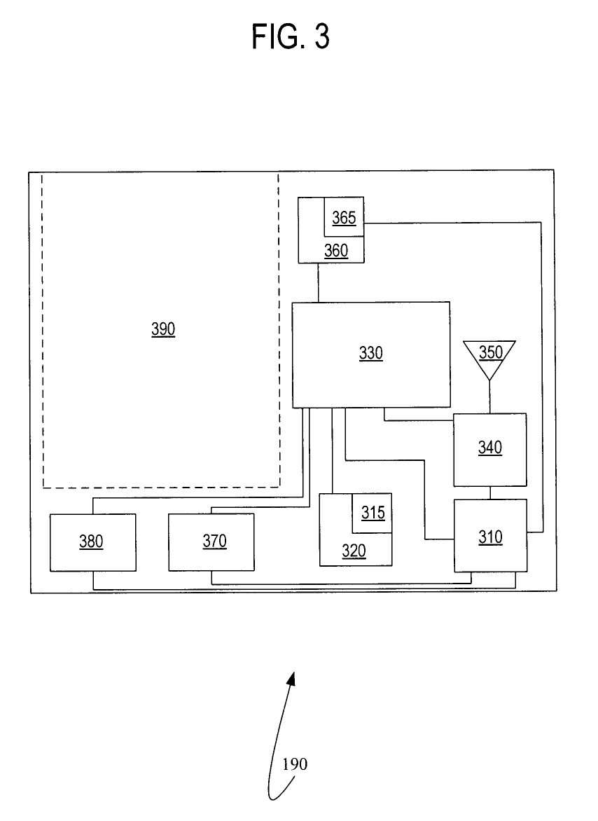

Referring now to FIG. 3, portable wireless device 190 further comprises processor 310, memory 320 interconnected with processor 310 via I/O interface 312, microcode 315 written to memory 320, power source 330, wireless device 340 interconnected to processor 310 via I/O interface 314, and antenna 350. In certain embodiment, device further comprises module 360, wherein module 360 is interconnected with processor 316 via I/O interface 316.wherein module 360 is capable of analyzing an identification card removeably inserted into device via input interface 260.

In certain embodiments, module 360 comprises a Fourier transform infrared analysis module, wherein module 360 generates an infrared beam and directs that infrared beam onto the surface of an inserted identification card. Module 360 then receives a reflected beam, and analyses that reflected beam to determine the chemical composition of the inserted identification card.

In certain embodiments, module 360 comprises a colorimeter, wherein that colorimeter can determine the one or more colors comprising a plurality of text and/or design features recited by an inserted identification card. In certain embodiments, module 360 can determine one or more dimensions, such as and without limitation length, width, and thickness, of an inserted identification card.

In certain embodiments, module 360 comprises hardware, firmware, and software, to store an image of a fingerprint read from a finger touching screen 210 (FIG. 2). In certain embodiments, module 360 comprises a U.are.0 4000 USB fingerprint reader sold in commerce by Digital Persona, Inc.

I/O interfaces 312, 314, and 316, may be any type of I/O interface. In certain embodiments, I/O interfaces 312, 314, and 316, are each independently selected from the group comprising a wireless communication link, a serial interconnection, such as RS-232 or RS-422, an Ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof

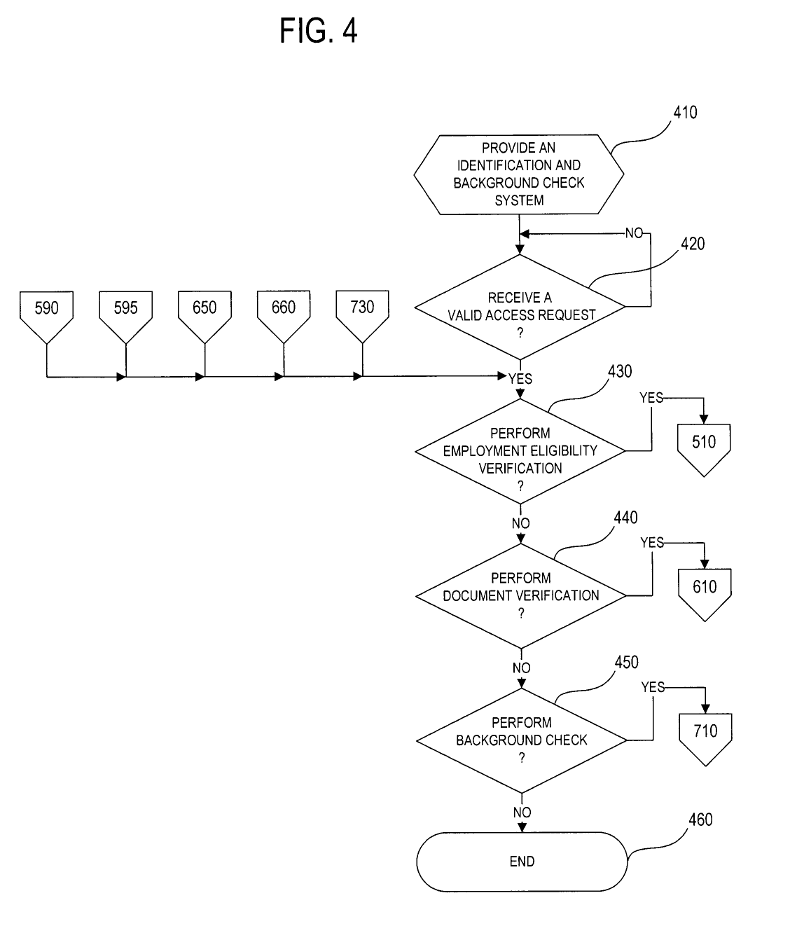

FIGS. 4-7 summarize the steps of Applicants' method using Applicants' apparatus to verify a person's identity. In certain embodiments, Applicants' invention further comprises a method to verify the authenticity of documents.

Referring now to FIG. 4, in step 410 Applicants' method provides a system, such as Applicants' system 100, to verify a person's identity and/or the authenticity of documents. In step 420, Applicants' method determines if a valid access request has been received. In certain embodiments, step 420 is performed by a host computer, such as host computer 110 (FIG. 1A), in communication with a requesting device, such as requesting device 180 (FIG. 1A)/190 (FIG. 1A), wherein that requesting device is requesting access to one or more databases in communication with host computer 110.

In certain embodiments, the access request of step 420 comprises providing by the requesting device a user name and/or password. In these embodiments, host computer 110 determines in step 420 whether a requesting device proffered a valid user name and/or password.

In certain embodiments, the access request of step 420 comprises an image of a fingerprint. In these embodiments, Applicants' host computer further comprises software, such as DigitalPersona IDentity Engine, sold in commerce by Digital Persona, Inc., wherein that software engine comprises algorithms that provide fingerprint verification. In these embodiments, host computer 110 determines in step 420 whether a requesting device proffered a valid fingerprint image.

In certain embodiments, the access request of step 420 comprises an image of a retinal scan. Biometrics which analyze the complex and unique characteristics of the eye can be divided into two different fields: iris biometrics and retina biometrics. The iris is the colored band of tissue that surrounds the pupil of the eye. An iris recognition system uses a video camera to capture the sample while the software compares the resulting data against stored templates. The retina is the layer of blood vessels at the back of the eye. Retinal scans are performed by directing a low-intensity infrared light to capture the unique retina characteristics. An area known as the face, situated at the center of the retina, is scanned and the unique pattern of the blood vessels is captured. In these retinal scan embodiments, host computer 110 determines in step 420 whether a requesting device proffered a valid image of a retinal scan.

If Applicants' method determines in step 420 that a valid access request has not been received, then the method continues to monitor for a valid access request. Alternatively, if Applicants' method determines in step 420 that a valid access request has been received, then the method transitions from step 420 to step 430 wherein the method determines whether to perform an employment eligibility verification. In certain embodiments, Applicants' method in step 430 displays the interrogatory PERFORM EMPLOYMENT ELIGIBILITY? on a display device interconnected with the requesting device of step 420, such as for example and without limitation display device 210 (FIG. 2) disposed on Applicants' portable device 190 (FIGS. 1, 2, 3). In response, the requesting device provides either a YES or a NO response.

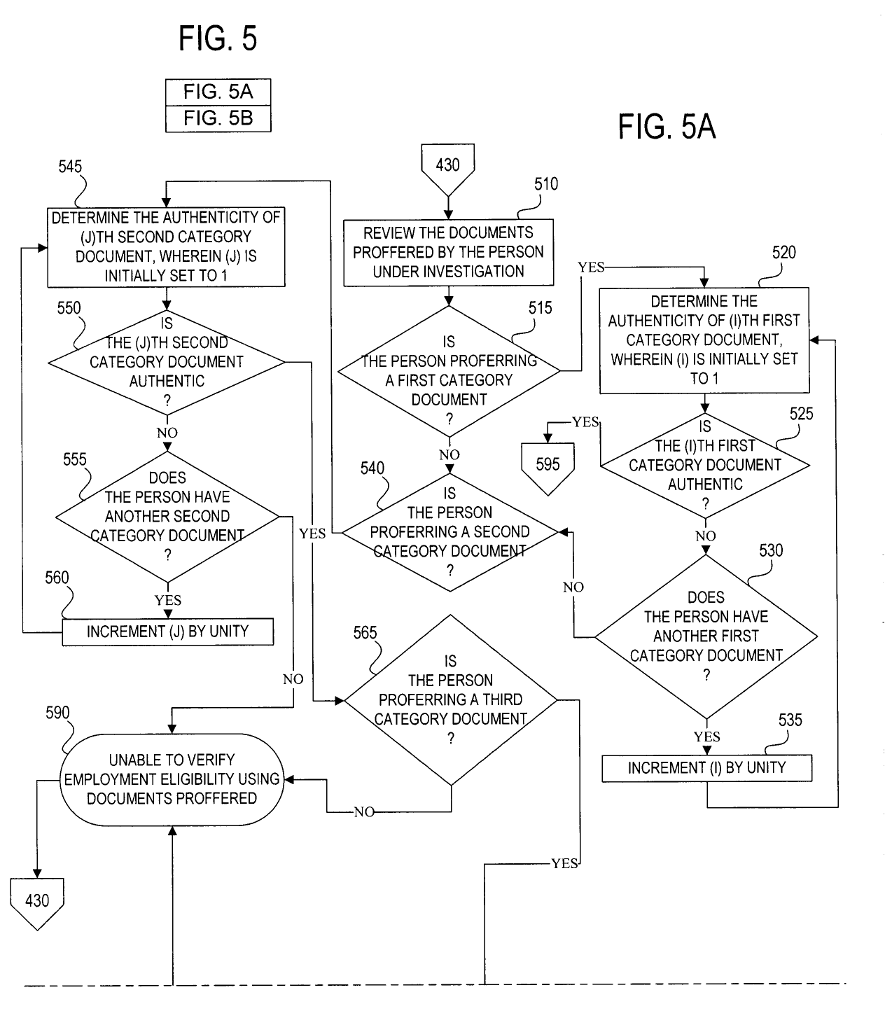

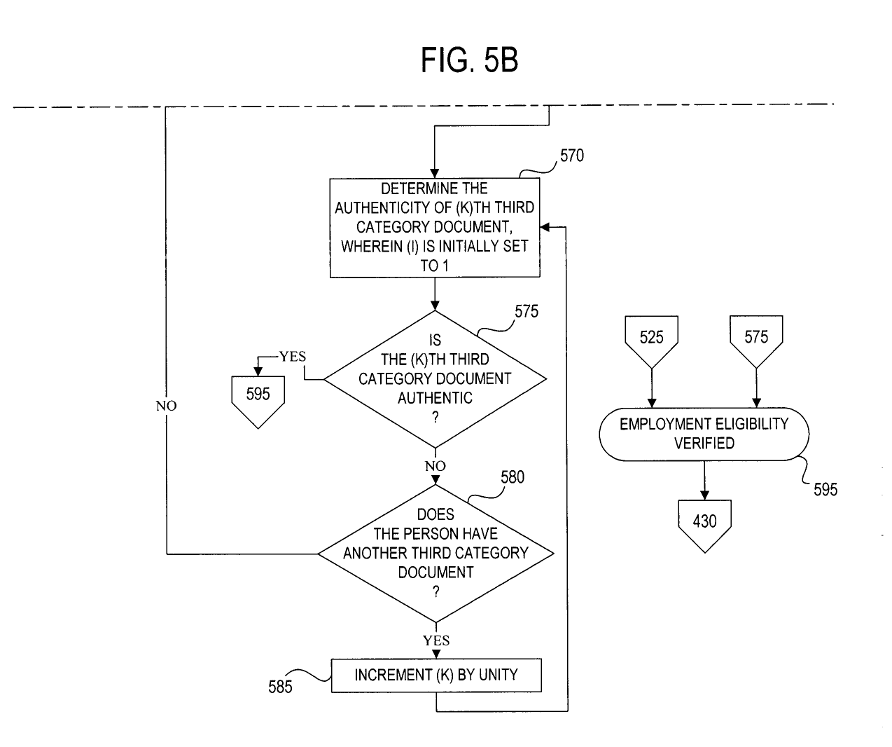

If Applicants' method elects in step 430 to verify the employment eligibility of a person, then the method transitions from step 430 to step 510 (FIG. 5). If Applicants' method elects in step 430 to not to verify the employment eligibility of a person, then the method transitions from step 430 to step 440 wherein the method determines whether to verify the authenticity of a document.

In certain embodiments, Applicants' method displays in step 440 the interrogatory PERFORM DOCUMENT VERIFICATION? on a display device interconnected with the requesting device of step 420, such as for example and without limitation display device 210 (FIG. 2) disposed on Applicants' portable device 190 (FIGS. 1, 2, 3). In response, the requesting device provides either a YES or a NO response.

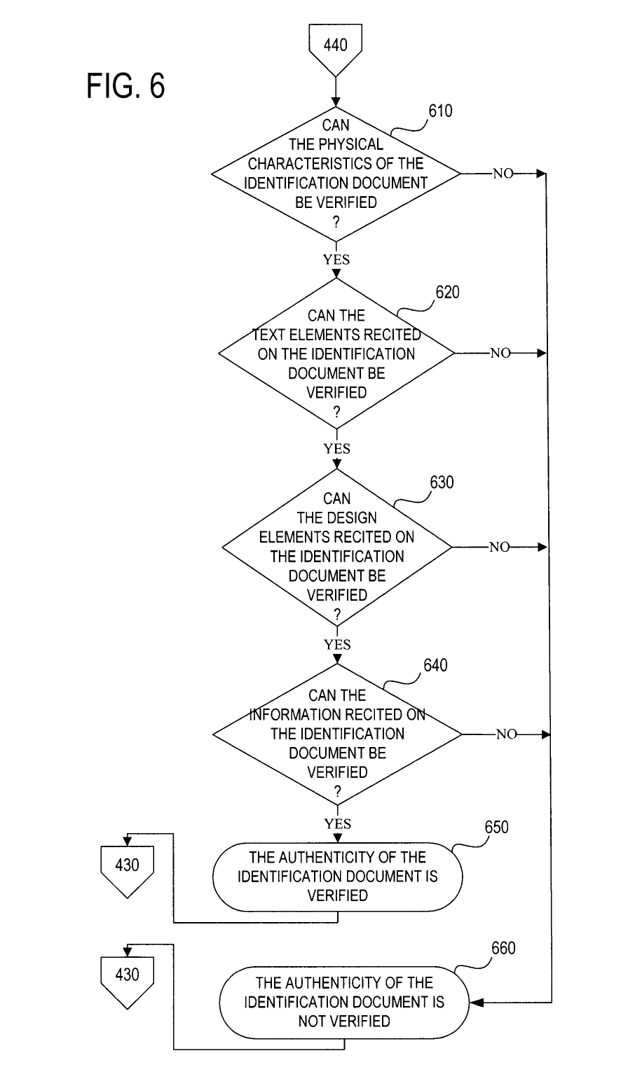

If Applicants' method elects in step 440 to verify the authenticity of a document, then the method transitions from step 440 to step 610 (FIG. 6). If Applicants' method elects in step 440 to not to verify authenticity of a document, then the method transitions from step 440 to step 450 wherein the method determines whether to perform a background check of a person.

In certain embodiments, Applicants' method displays in step 450 the interrogatory PERFORM BACKGROUND CHECK? on a display device interconnected with the requesting device of step 420, such as for example and without limitation display device 210 (FIG. 2) disposed on Applicants' portable device 1980 (FIGS. 1, 2, 3). In response, the requesting device provides either a YES or a NO response.

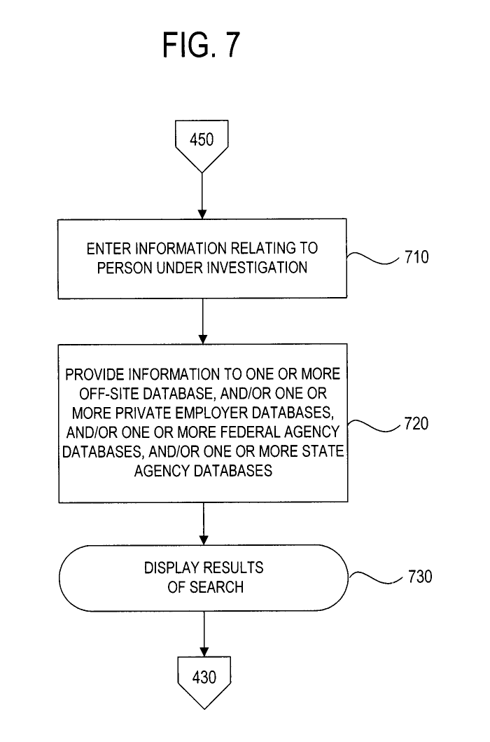

If Applicants' method elects in step 450 to perform a background check, then the method transitions from step 450 to step 710 (FIG. 7). If Applicants' method elects in step 440 to not to perform a background check, then the method transitions from step 450 to step 460 and ends.

FIG. 5 summarizes the steps of Applicants' method to verify a person's employment eligibility. In certain embodiments, Applicants' method utilizes a Form I-9 entitled Employment Eligibility Verification.

Referring now to FIG. 5, in step 510 Applicants' method reviews the documents proffered by the person under investigation. For purposes of Form I-9, it is acceptable to use either one document from a First Document Category, wherein that First Document Category comprises a U.S. Passport, INS Form N-560 or N-561, INS Form N-550 or N-570, unexpired foreign passport with I-551 stamp or attached INS Form I-94 indicating unexpired employment authorization, INS Form I-151 or I-551, INS Form I-688, INS Form I-688A, INS Form I-327, INS Form I-571, or INS Form I-688B.

For purposes of Form I-9, it is acceptable to use one Second Category Document, in combination with one Third Category Document. Such a Second Category Document may comprise a driver's license or ID card issued by a state containing a photograph or information such as name, date of birth, sex, height, eye color, and address, ID card issued by federal, state, or local government agencies or entities containing a photograph or information such as name, date of birth, sex, height, eye color, and address, a school ID card with photograph, voter's registration card, U.S. military card or draft record, military dependent's ID card, U.S. Coast Guard Merchant Mariner Card, Native American tribal document, or driver's license issued by a Canadian government authority, or for individuals under 18, a school record or report card, clinic, doctor or hospital record, or day-care or nursery school record.

Such a Third Category Document may comprise a U.S. social security card issued by the Social Security Administration, Certification of Birth Abroad issue by the Department of State, original or certified copy of a birth certificate issued by a state, county, municipal authority or outlying possession of the United States bearing an official seal, Native American tribal document, INS Form I-197, INS Form I-179, or other unexpired employment authorization document issued by INS.

In step 515, Applicants' method determines if the person under investigation can proffer a First Category Document. If Applicants' method determines in step 515 that the person under investigation is proffering a First Category Document, then the method transitions from step 515 to step 520 wherein the method determines the authenticity of the (i)th First Category Document, wherein (i) is initially set to 1.

In certain embodiments, step 520 utilizes the steps recited in FIG. 6. In certain embodiments, step 520 comprises visually comparing a photograph recited on the (i)th First Category Document with the person under investigation.

In certain embodiments, step 520 comprises providing to Applicants' host computer, such as and without limitation host computing device 110 (FIG. 1A), the security features recited by the (i)th First Category Document. In these embodiments, Applicants' host computer determines if the (i)th First Category Document comprises the specific security features that should be recited by an authentic (i)th First Category Document. In certain embodiments, step 520 comprises using for example and without limitation requesting device 180 (FIG. 1A) or 190 (FIG. 1A) to request from Applicants' host computer 110 (FIG. 1A) information relating to the specific security features that should be recited by the (i)th First Category Document, and then visually examining the (i)th First Category Document to determine if those security feature are actually present.

If Applicants' method determines that the (i)th First Category Document comprises the required security features, and if a photograph recited in the (i)th First Category Document visually matches the person under investigation, and optionally if the document verification algorithm recited in FIG. 6 indicates the (i)th First Category Document is authentic, then Applicants' method in step 525 determines that the (i)th First Category Document is authentic, and the method transitions from step 525 to step 595 wherein the method verifies the employment eligibility of the person being investigated. In certain embodiments, in step 595 Applicants' method electronically fills out Form I-9. The electronic format of Form I-9 can be, for example, a modifiable portable document format (PDF) or a template. In certain embodiments, step 595 further comprises printing the Form I-9. In certain embodiments, step 595 further comprises storing the generated Form I-9. Applicants' method transitions from step 595 to step 430 and continues as described herein.

Alternatively, if Applicants' method determines that the (i)th First Category Document does not comprise the required security features, and/or if the photograph recited in the (i)th First Category Document does not visually match the person under investigation, and/or if the document verification algorithm recited in FIG. 6 indicates the (i)th First Category Document is not authentic, then Applicants' method in step 525 determines that the (i)th First Category Document is not authentic.

If Applicants' method in step 525 determines that the (i)th First Category Document is not authentic, then the method transitions from step 525 to step 530 wherein the method determines if the person under investigation can proffer another First Category Document. If Applicants' method determines in step 530 that the person under investigation can proffer another First Category Document, then the method transitions from step 530 to step 535 wherein the method increments (i) by unity, and then transitions from step 535 to step 520 and continues as described herein.

Alternatively, if Applicants' method determines in step 530 that the person under investigation cannot proffer another First Category Document, then the method transitions from step 530 to step 540 wherein the method determines if the person under investigation can proffer a Second Category Document. If Applicants' method determines in step 540 that the person under investigation can proffer a Second Category Document, then the method transitions from step 540 to step 545 wherein the method determines the authenticity of the (j)th Second Category Document, wherein (j) is initially set to 1.

In certain embodiments, step 545 utilizes the steps recited in FIG. 6. In certain embodiments, step 545 comprises visually comparing a photograph recited on the (j)th Second Category Document with the person under investigation.

In certain embodiments, step 545 comprises providing to Applicants' host computer, such as and without limitation host computing device 110 (FIG. 1A), the security features recited by the (j)th Second Category Document. In these embodiments, Applicants' host computer determines if the (j)th Second Category Document comprises the specific security features that should be recited by an authentic (j)th Second Category Document. In certain embodiments, step 545 comprises using for example and without limitation requesting device 180 (FIG. 1A) or 190 (FIG. 1A) to request from Applicants' host computer 110 (FIG. 1A) information relating to the specific security features that should be recited by the (j)th Second Category Document, and then visually examining the (j)th Second Category Document to determine if those security feature are actually present.

If Applicants' method determines that the (j)th Second Category Document comprises the required security features, and if a photograph recited in the (j)th Second Category Document visually matches the person under investigation, and optionally if the document verification algorithm recited in FIG. 6 indicates the (j)th Second Category Document is authentic, then Applicants' method in step 550 determines that the (j)th Second Category Document is authentic, and the method transitions from step 550 to step 565.

Alternatively, if Applicants' method determines that the (j)th Second Category Document does not comprise the required security features, and/or if a photograph recited in the (j)th Second Category Document does not visually match the person under investigation, and/or if the document verification algorithm recited in FIG. 6 indicates the (j)th Second Category Document is not authentic, then Applicants' method in step 550 determines that the (j)th Second Category Document is not authentic.

If Applicants' method in step 550 determines that the (j)th Second Category Document is not authentic, then Applicants' method transitions from step 550 to step 555 wherein the method determines if the person under investigation can proffer another Second Category Document. If Applicants' method determines in step 555 that the person under investigation can proffer another Second Category Document, then the method transitions from step 555 to step 560 wherein the method increments (j) by unity, and then transitions from step 560 to step 545 and continues as described herein.

Alternatively, if Applicants' method determines in step 555 that the person under investigation cannot proffer another Second Category Document, then the method transitions from step 555 to step 590 wherein the method reports that it is unable to verify employment eligibility using the documents proffered by the person under investigation.

In step 565, Applicants' method determines if the person under investigation can proffer a Third Category Document. If Applicants' method determines in step 565 that the person under investigation can proffer a Third Category Document, then the method transitions from step 565 to step 570 wherein the method determines the authenticity of the (k)th Third Category Document, wherein (k) is initially set to 1.

In certain embodiments, step 570 utilizes the steps recited in FIG. 6. In certain embodiments, step 570 comprises visually comparing a photograph recited on the (j)th Second Category Document with the person under investigation.

In certain embodiments, step 570 comprises providing to Applicants' host computer, such as and without limitation host computing device 110 (FIG. 1A), the security features recited by the (k)th Third Category Document. In these embodiments, Applicants' host computer determines if the (k)th Third Category Document comprises the specific security features that should be recited by an authentic (k)th Third Category Document. In certain embodiments, step 570 comprises using for example and without limitation requesting device 180 (FIG. 1A) or 190 (FIG. 1A) to request from Applicants' host computer 110 (FIG. 1A) information relating to the specific security features that should be recited by the (k)th Third Category Document, and then visually examining the (k)th Third Category Document to determine if those security feature are actually present.

If Applicants' method determines that the (k)th Third Category Document comprises the required security features, and if a photograph recited in the (k)th Third Category Document visually matches the person under investigation, and optionally if the document verification algorithm recited in FIG. 6 indicates the (k)th Third Category Document is authentic, then Applicants' method in step 575 determines that the (k)th Third Category Document is authentic, and the method transitions from step 575 to step 595.

In certain embodiments, in step 595 Applicants' method electronically fills out Form I-9. The electronic format of Form I-9 can be, for example, a modifiable portable document format (PDF) or a template. In certain embodiments, step 595 further comprises printing the Form I-9. In certain embodiments, step 595 further comprises storing the generated Form I-9. Applicants' method transitions from step 595 to step 430 and continues as described herein.

Alternatively, if Applicants' method determines that the (k)th Third Category Document does not comprise the required security features, and/or if the photograph recited in the (k)th Third Category Document does not visually match the person under investigation, and/or if the document verification algorithm recited in FIG. 6 indicates the (k)th Third Category Document is not authentic, then Applicants' method in step 575 determines that the (k)th Third Category Document is not authentic.

If Applicants' method in step 575 determines that the (k)th Third Category Document is not authentic, then Applicants' method transitions from step 575 to step 580 wherein the method determines if the person under investigation can proffer another Third Category Document. If Applicants' method determines in step 580 that the person under investigation can proffer another Third Category Document, then the method transitions from step 580 to step 585 wherein the method increments (k) by unity, and then transitions from step 585 to step 570 and continues as described herein.

Alternatively, if Applicants' method determines in step 580 that the person under investigation cannot proffer another Third Category Document, then the method transitions from step 580 to step 590 wherein the method reports that it is unable to verify employment eligibility using the documents proffered by the person under investigation.

FIG. 6 summarizes the steps of Applicants' method to verify the authenticity of a document. Referring now to FIG. 6, in step 610 Applicants' method determines if the physical characteristics of the document can be verified. In certain embodiments, the physical characteristics of the document are provided to host computer from a requesting computing device, such as requesting computing device 180 and/or 190. In certain embodiments, step 610 comprises determining, inter alia, the length, width, and thickness of the proffered document, and then matching those measured dimensions with document dimension standards obtained from one or more off-site databases, such as databases 130 and 140, and/or one or more federal agency databases, such as federal agency database 160, and/or one or more state agency databases, such as state agency database 170. In certain embodiments, Applicants' hand-held device 190 comprises a laser displacement sensor 380 (FIG. 3) disposed therein. In certain embodiments, that laser displacement sensor comprises a device sold by Schmitt Measurement Systems under the product name Acuity AR600. In certain embodiments, Applicants' laser displacement sensor utilizes the apparatus and method described in United States Pat. No. 6,624,899, which is hereby incorporated by reference herein. In certain embodiments, the physical characteristics of the proffered document are automatically determined using Applicants' device 190, wherein that proffered document is inserted into document analysis area 390 disposed in device 190, and wherein processor 310 380 (FIG. 3) using laser displacement sensor 380 (FIG. 3), and microcode 315 (FIG. 3), determines the dimensions of the inserted document. In these embodiments, device 190 downloads document dimension standards from one or more off-site databases, such as databases 130 and 140, and/or one or more federal agency databases, such as federal agency database 160, and/or one or more state agency databases, such as state agency database 170. Processor 310, using microcode 315, compares the measured dimensions with the downloaded agency standards, and determines if the physical characteristics of the proffered document can be verified in step 610.

In certain embodiments, step 610 comprises determining, inter alia, the color of various elements of the proffered document, and matching those measured colors with document color standards obtained from one or more off-site databases, such as databases 130 and 140, and/or one or more federal agency databases, such as federal agency database 160, and/or one or more state agency databases, such as state agency database 170.

In certain embodiments, the color of various elements of the proffered document are automatically determined using Applicants' device 190, wherein that proffered document is inserted into document analysis portion 390 of device 190 and wherein colorimeter 370 (FIG. 3) determines the colors disposed in that document. In these embodiments, device 190 downloads document color standards from one or more off-site databases, such as databases 130 and 140, and/or one or more federal agency databases, such as federal agency database 160, and/or one or more state agency databases, such as state agency database 170. Processor 310, using microcode 315, matches the measured colors with the downloaded agency standards, and determines if the colored elements of the proffered document can be verified in step 610.

In certain embodiments, step 610 comprises determining, inter alia, the composition of the proffered document, and matching that measured composition with document composition standards obtained from one or more off-site databases, such as databases 130 and 140, and/or one or more federal agency databases, such as federal agency database 160, and/or one or more state agency databases, such as state agency database 170.

In certain embodiments, the composition of the proffered document are automatically determined using Applicants' device 190, wherein that proffered document is inserted into device 190 and wherein module 360 (FIG. 3) comprises a Fourier transform infrared spectrometer. In these embodiments, device 190 downloads document composition standards from one or more off-site databases, such as databases 130 and 140, and/or one or more federal agency databases, such as federal agency database 160, and/or one or more state agency databases, such as state agency database 170. Processor 310, using microcode 315, matches the determined composition with the downloaded composition standards, and determines if the composition of the proffered document can be verified in step 610.

If Applicants' method determines in step 610 that the physical characteristics of the proffered document cannot be verified, then the method transitions from step 610 to step 660 wherein the method determines that the authenticity of the identification document cannot be verified. In certain embodiments, that determination is displayed on a visual display device interconnected with the requesting computing device, such as display 210 disposed on device 190. Applicants' method transitions from step 660 to step 430 and continues as described herein.

Alternatively, if Applicants' method determines in step 610 that the physical characteristics of the proffered document can be verified, then the method transitions from step 610 to step 620 wherein the method determines if the proffered identification document comprises all the required text areas.

In certain embodiments, step 620 comprises determining, inter alia, the locations and sizes of each text element recited on the proffered document. In certain embodiments, the proffered identification document is inserted into document analysis portion 390 of hand-held device 190. Processor 310, using microcode 315, laser displacement device 380, optical scanner 360, and optical character recognition algorithm 365, identifies and measures the location and size of each text element recited on the proffered identification document.

By “text element,” Applicant means one or more features recited on an identification document, wherein optical character recognition algorithm identifies those one or more features as one or more letters. In certain embodiments, step 630 further comprises determining using colorimeter 380 one or more colors comprising the one or more identified letters.

In certain embodiments, determining the location of a text element comprises forming a rectangle that encloses each letter disposed in the text element, and then determining, using a two-dimensional Cartesian coordinate system the coordinates for each corner of that rectangle. In certain of these embodiments, the size of the text element comprises the length, width, and area, of the formed rectangle.

In certain embodiments, the origin of the two-dimensional Cartesian coordinate system is placed one corner of the identification document. In certain embodiments, the origin of the two-dimensional Cartesian coordinate system is placed at a center point of the identification document.

Applicants' method compares the measured text area sizes and locations, and optionally one or more colors, with document composition standards obtained from one or more off-site databases, such as databases 130 and 140, and/or one or more federal agency databases, such as federal agency database 160, and/or one or more state agency databases, such as state agency database 170. In certain embodiments, the locations and sizes of each text element recited on the proffered document are provided to host computer 110 (FIG. 1A) from a requesting computing device, such as requesting computing device 180 (FIG. 1A) and/or 190 (FIG. 1A).

If Applicants' method determines in step 620 that the locations and sizes of each text element recited on the proffered document cannot be verified, then the method transitions from step 620 to step 660 wherein the method determines that the authenticity of the identification document cannot be verified. In certain embodiments, that determination is displayed on a visual display device interconnected with the requesting computing device, such as display 210 disposed on device 190.

Alternatively, if Applicants' method determines in step 620 that the locations and sizes of each text element recited on the proffered document can be verified, then the method transitions from step 620 to step 630 wherein the method determines if the proffered identification document comprises all the required design elements. In certain embodiments, the locations and sizes of each design element recited on the proffered document are provided to host computer 110 (FIG. 1A) from a requesting computing device, such as requesting computing device 180 (FIG. 1A) and/or 190 (FIG. 1A).

In certain embodiments, step 630 comprises determining, inter alia, the locations and sizes of each design element recited on the proffered document. In certain embodiments, the proffered identification document is inserted into document analysis portion 390 of hand-held device 190. Processor 310, using microcode 315, laser displacement device 380, optical scanner 360, and optical character recognition algorithm 365, identifies and measures the location and size of each text element recited on the proffered identification document.

By “design element,” Applicant means one or more features recited on an identification document, wherein optical character recognition algorithm does not identify those one or more features as one or more letters. In certain embodiments, step 630 further comprises determining the one or more colors comprising the one or more features that do not comprise identified letters.

In certain embodiments, determining the location of a design element comprises forming a rectangle that encloses each feature disposed in the design element, and then determining, using a two-dimensional Cartesian coordinate system the coordinates for each corner of that rectangle. In certain of these embodiments, the size of the text element comprises the length, width, and area, of the formed rectangle.

In certain embodiments, the origin of the two-dimensional Cartesian coordinate system is placed one corner of the identification document. In certain embodiments, the origin of the two-dimensional Cartesian coordinate system is placed at a center point of the identification document.

Applicants' method compares the measured design area sizes and locations, and optionally colors, with document composition standards obtained from one or more off-site databases, such as databases 130 and 140, and/or one or more federal agency databases, such as federal agency database 160, and/or one or more state agency databases, such as state agency database 170. In certain embodiments, the locations and sizes, and optionally colors, of each design element recited on the proffered document are provided to host computer 110 (FIG. 1A) from a requesting computing device, such as requesting computing device 180 (FIG. 1A) and/or 190 (FIG. 1A).

If Applicants' method determines in step 630 that the locations and sizes, and optionally colors, of each design element recited on the proffered document cannot be verified, then the method transitions from step 630 to step 660 wherein the method determines that the authenticity of the identification document cannot be verified. In certain embodiments, that determination is displayed on a visual display device interconnected with the requesting computing device, such as display 210 disposed on device 190.

Alternatively, if Applicants' method determines in step 630 that the locations and sizes of each design element recited on the proffered document can be verified, then the method transitions from step 630 to step 640 wherein the method determines if the information recited on the proffered identification document can be verified. In certain embodiments, the information recited on the proffered document is provided to host computer 110 (FIG. 1A) from a requesting computing device, such as requesting computing device 180 (FIG. 1A) and/or 190 (FIG. 1A).

In certain embodiments, the determination whether the information recited on the proffered identification document can be verified is performed automatically using Applicants' device 190. In certain embodiments, the proffered identification document is inserted into document analysis portion 390 of hand-held device 190. Processor 310, using microcode 315, optical scanner 360, and optical character recognition algorithm 365, abstracts the information recited on the proffered identification document. In these embodiments, device 190 provides that abstracted information for verification to one or more off-site databases, such as databases 130 and 140, and/or one or more federal agency databases, such as federal agency database 160, and/or one or more state agency databases, such as state agency database 170. Processor 310, using microcode 315, matches the information recited on the proffered identification document with the information returned from the one or more databases to determine in step 640 if the information recited on the proffered identification document can be verified.

If Applicants' method determines in step 640 that the information recited on the proffered identification document cannot be verified, then the method transitions from step 640 to step 660 wherein the method determines that the authenticity of the identification document cannot be verified. In certain embodiments, that determination is displayed on a visual display device interconnected with the requesting computing device, such as display 210 disposed on device 190.

Alternatively, if Applicants' method determines in step 640 that the information recited on the proffered identification document can be verified, then the method transitions from step 640 to step 650 wherein he method determines that the authenticity of the identification document can be verified. In certain embodiments, that determination is displayed on a visual display device interconnected with the requesting computing device, such as display 210 disposed on device 190. Applicants' method transitions from step 650 to step 430 and continues as described herein.

FIG. 7 summarizes the steps of Applicants' method to obtain a background check on a person under investigation. Referring now to FIG. 7, in step 710 Applicants' method determines information relating to the person under investigation. In certain embodiments, that information is provided to host computer from a requesting computing device, such as requesting computing device 180 and/or 190.

In step 720, Applicants' method provides the information of step 710 to one or more off-site databases, such as databases 130 and 140, and/or one or more federal agency databases, such as federal agency database 160, and/or one or more state agency databases, such as state agency database 170.

In step 730, Applicants' method displays on a visual display device interconnected to the requesting computing device the information returned from the one or more off-site databases, such as databases 130 and 140, and/or one or more federal agency databases, such as federal agency database 160, and/or one or more state agency databases, such as state agency database 170. Applicants' method transitions from step 730 to step 430 and continues as described herein.

The foregoing description of the invention is with reference to specific example embodiments. The specification and drawings are accordingly to be regarded as illustrative rather than in a restrictive sense. It is, however, evident that various modifications and changes may be made, in a computer program product or software, hardware or any combination thereof, without departing from the broader spirit and scope of the present invention.

Software embodiments of the present invention may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may be applicable in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software causes the processor to perform an action to produce a result.

While this invention has been particularly shown and described with references to preferred embodiments thereof, it will be understood by those skilled in the art that various changes in form and details may be made therein without departing from the scope of the invention encompassed by the appended claim.

We claim:

1. A method to verify a person's employment, comprising the steps of:
selecting a person under investigation;
determining if said person can proffer an authentic first category document selected from the group consisting of a United States Passport, United States Immigration and Naturalization Service (“INS”) Form N-560 or N-561, INS Form N-550 or N-570, an unexpired foreign passport with I-551 stamp or attached INS Form I-94 indicating unexpired employment authorization, INS Form I-151 or I-551, INS Form I-688, INS Form I-688A, INS Form I-327, INS Form I-571, and INS Form I-688B;
operative if said person can proffer an authentic first category document, verifying said person's employment.

2. The method of claim 1, further comprising the steps of:
operative if person cannot proffer an authentic first category document, determining if said person can proffer an authentic second category document selected from the group consisting of: a driver's license or identification card issued by a state containing a photograph or information such as name, date of birth, sex, height, eye color, and address, an identification card issued by a federal, state, or local government agency comprising a photograph or information such as name, date of birth, sex, height, eye color, and address, a school identification card comprising a photograph, a voter's registration card, a United States military identification card or draft record, a military dependent's identification card, United States Coast Guard Merchant Mariner Card, a Native American tribal document, or driver's license issued by a Canadian government authority;
operative if said person cannot proffer an authentic second category document, not verifying said person's employment.

3. The method of claim 3, further comprising the steps of:
operative if said person can proffer an authentic second category document, determining if said person can proffer an authentic third category document selected from the group consisting of a U.S. social security card issued by the Social Security Administration, Certification of Birth Abroad issue by the Department of State, original or certified copy of a birth certificate issued by a state, county, municipal authority or outlying possession of the United States bearing an official seal, Native American tribal document, INS Form I-197, INS Form I-179, or other unexpired employment authorization document issued by INS;
operative if said person cannot proffer an authentic second category document and an authentic third category document, not verifying said person's employment;
operative if said person can proffer an authentic second category document and an authentic third category document, verifying said person's employment.

4. A hand-held article of manufacture comprising a visual display device, a processor, and a computer readable medium having computer readable program code disposed therein to verify a person's employment of a person under investigation, the computer readable program code comprising a series of computer readable program steps to effect:
determining the authenticity of a proffered first category document selected from the group consisting of a United States Passport, United States Immigration and Naturalization Service (“INS”) Form N-560 or N-561, INS Form N-550 or N-570, an unexpired foreign passport with I-551 stamp or attached INS Form I-94 indicating unexpired employment authorization, INS Form I-151 or I-551, INS Form I-688, INS Form I-688A, INS Form I-327, INS Form I-571, and INS Form I-688B;
operative if said proffered first category document is authentic, verifying said person's employment.

5. The article of manufacture of claim 4, said computer readable program code further comprising a series of computer readable program steps to effect:
determining the authenticity of a proffered second category document selected from the group consisting of: a driver's license or identification card issued by a state containing a photograph or information such as name, date of birth, sex, height, eye color, and address, an identification card issued by a federal, state, or local government agency comprising a photograph or information such as name, date of birth, sex, height, eye color, and address, a school identification card comprising a photograph, a voter's registration card, a United States military identification card or draft record, a military dependent's identification card, United States Coast Guard Merchant Mariner Card, a Native American tribal document, or driver's license issued by a Canadian government authority;
operative if said person cannot proffer an authentic first category document or an authentic second category document, not verifying said person's employment.

6. The article of manufacture of claim 5, said computer readable program code further comprising a series of computer readable program steps to effect:
determining the authenticity of a proffered third category document selected from the group consisting of a U.S. social security card issued by the Social Security Administration, Certification of Birth Abroad issue by the Department of State, original or certified copy of a birth certificate issued by a state, county, municipal authority or outlying possession of the United States bearing an official seal, Native American tribal document, INS Form I-197, INS Form I-179, or other unexpired employment authorization document issued by INS;
operative if said person cannot proffer an authentic second category document and an authentic third category document, not verifying said person's employment;
operative if said person can proffer an authentic second category document and an authentic third category document, verifying said person's employment.

7. A method to verify the authenticity of an identification document, wherein said identification document comprises one or more physical characteristics, one or more text areas, and one or more design elements, comprising the steps of:
determining if said one or more physical characteristics can be verified;
determining if said one or more text areas can be verified;
determining if said one or more design elements can be verified.

8. The method of claim 7, wherein said determining if one or more physical characteristics can be verified step further comprises the steps of:
calculating the length, width, and thickness, of an identification document;
comparing said measured length, width, and thickness, with pre-determined document composition standards associated with said identification document.

9. The method of claim 7, wherein said determining if one or more text elements can be verified step further comprises the steps of:
identifying each text element recited by said identification document;
calculating the size and location of each identified text element;
comparing the size and location of each identified text element with pre-determined document composition standards associated with said identification document.

10. The method of claim 9, further comprising the steps of:
identifying one or more colors comprising each text element recited by said identification document;
comparing the one or more colors recited by each identified text element with pre-determined document composition standards associated with said identification document.

11. The method of claim 7, wherein said determining if one or more design elements recited on said identification document can be verified step further comprises the steps of:
identifying each design element recited by said identification document;
calculating the size and location of each identified design element;
comparing the size and location of each identified design element with pre-determined document composition standards associated with said identification document.

12. The method of claim 11, further comprising the steps of:
identifying one or more colors comprising each design element recited by said identification document;
comparing the one or more colors recited by each identified design element with pre-determined document composition standards associated with said identification document.

13. The method of claim 12, further comprising the steps of:
supplying a hand-held computing device comprising a processor, an optical scanner, a colorimeter, a laser displacement sensor, a computer readable medium, microcode encoded in said computer readable medium, and an optical character recognition algorithm encoded in said computer readable medium;
inserting said identification document into said hand-held computing device;
performing said identifying, calculating, and comparing, steps, by said processor using said optical scanner, said colorimeter, said laser displacement sensor, said computer readable medium, said microcode, and said optical character recognition algorithm.

14. A hand-held computing device comprising a processor, a computer readable medium, and a computer readable medium having computer readable program code encoded in said computer readable medium, wherein said computer readable code is useable with said processor to verify the authenticity of an identification document, wherein said identification document comprises one or more physical characteristics, one or more text areas, and one or more design elements, the computer readable program code comprising a series of computer readable program steps to effect:
determining if said one or more physical characteristics can be verified;
determining if said one or more text areas can be verified;
determining if said one or more design elements can be verified.

15. The hand-held computing device of claim 14, further comprising a laser displacement sensor, wherein said computer readable program code to determine if one or more physical characteristics can be verified step further comprises a series of computer readable program steps to effect:
calculating the length, width, and thickness, of an identification document;
wirelessly receiving pre-determined document composition standards associated with said identification document;
comparing said measured length, width, and thickness, with said pre-determined document composition standards associated with said identification document.

16. The hand-held computing device of claim 14, further comprising an optical scanner, a laser displacement sensor, and an optical character recognition algorithm encoded in said computer readable medium, wherein said computer readable program code to determine if one or more text elements can be verified step further comprises a series of computer readable program steps to effect:
identifying each text element recited by said identification document;
calculating the size and location of each identified text element;
wirelessly receiving pre-determined document composition standards associated with said identification document;
comparing the size and location of each identified text element with said pre-determined document composition standards associated with said identification document.

17. The hand-held computing device of claim 16, further comprising a colorimeter, wherein said computer readable program code to determine if one or more text elements can be verified step further comprises a series of computer readable program steps to effect:
identifying one or more colors comprising each text element recited by said identification document;
comparing the one or more colors recited by each identified text element with said pre-determined document composition standards associated with said identification document.

18. The hand-held computing device of claim 14, further comprising an optical scanner, a laser displacement sensor, and an optical character recognition algorithm encoded in said computer readable medium, wherein said computer readable program code to determine if one or more design elements recited on said identification document can be verified step further comprises a series of computer readable program steps to effect:
identifying each design element recited by said identification document;
calculating the size and location of each identified design element;
wirelessly receiving pre-determined document composition standards associated with said identification document;
comparing the size and location of each identified design element with pre-determined document composition standards associated with said identification document.

19. The hand-held computing device of claim 18, further comprising a colorimeter, wherein said computer readable program code to determine if one or more text elements can be verified step further comprises a series of computer readable program steps to effect:
identifying one or more colors comprising each design element recited by said identification document;
comparing the one or more colors recited by each identified design element with pre-determined document composition standards associated with said identification document.

20. The hand-held computing device of claim 14, further comprising a visual display device, said computer readable program code further comprising a series of computer readable program steps to effect:
operative if said one or more physical characteristics, and said one or more text elements, and said one or more design elements, can be verified, displaying on said visual display device a message that said identification document has been verified;
operative if said one or more physical characteristics, or said one or more text elements, or said one or more design elements, cannot be verified, displaying on said visual display device a message that said identification document cannot be verified.
